(19) United States
(12) Patent Application Publication
(10) Pub. No.: US 2011/0081993 A1
(43) Pub. Date: Apr. 7, 2011

(54) GOLF TEE AND METHOD OF PRODUCING A GOLF TEE

(75) Inventor: Swee Hoe Phua, Singapore (SG)

(73) Assignee: Inzign PTE Ltd., Singapore (SG)

(21) Appl. No.: 12/995,623

(22) PCT Filed: May 28, 2009
(86) PCT No.: PCT/SG2009/000188

§ 371 Date: Dec. 1, 2010

(30) Foreign Application Priority Data
Jun. 2, 2008 (SG) 200804360-6

(51) Int. Cl. A63B 57/00; B29C 71/02

(52) U.S. Cl. 473/396; 264/235

(57) ABSTRACT

A golf tee (100) for supporting a golf ball (300) is disclosed herein. In a preferred embodiment, the golf tee (100) comprises a stem section (102) insertable to the ground (200) and a head section (104) for supporting the golf ball (300) and arranged to be releasably attached to the stem section (102). A connection member (106 )is configured to tie the stem section to the head section and which enables the head section (104) to be detached from stem section (102). In this way, when the head section (104) is struck by a golf club and becomes detached from the stem section (102), the connection member (106) prevents the head section (104) from being separated from the stem section (102). Since the stem section (102) is likely to be planted into the ground, this reduces the chance of sending the golf tee (100) flying and thus, there is no need to spend time searching for the golf tee (100). A method of producing a golf tee is also disclosed.

### BACKGROUND AND FIELD OF THE INVENTION

This invention relates to a golf tee, as well as method of producing a golf tee.

In a game of golf, it is common to begin a first stroke of each hole at the “teeing ground” and a golf tee is normally used to “tee off”. A conventional golf tee is usually made of wood or plastic and has a head for a golf ball to rest on and a connecting stem that is pointed at one end for inserting into the ground. The golf tee is then positioned so that the golf ball, when supported by the head of the golf tee, is substantially on the same level as the ground/grass surface. The head of the golf tee is thus usually above the ground and quite often, part of the connecting stem too since depending on which type of golf club (“irons” or “woods”) used to tee off, the height of the golf ball relative to the ground needs to be adjusted higher by adjusting the depth of penetration of the golf tee into the ground.

When a golfer swings a golf club to hit the golf ball, more often than not the swing would also hit the golf tee sending the golf tee flying. It is usual to track the flight of the golf ball but not where the golf tee went and thus, often time is wasted searching for the golf tee which delays the game. Further, if the golf club also hits exposed area of the golf tee, it is not uncommon for the exposed area to be broken and the golf tee has to be replaced. For these reasons, golfers tend to carry a number of golf tees for each game of golf.

It is an object of the present invention to provide a golf tee to address at least one of the above prior art problems and/or to provide the public with a useful choice.

### SUMMARY OF THE INVENTION

In a first aspect of the invention, there is provided a golf tee comprising
a stem section insertable to the ground;
a head section for supporting a golf ball and arranged to be releasably attached to the stem section.

To use the golf tee of the preferred embodiment, the stem section is inserted into the ground with the head section exposed. Since the head section is releasably attached to the stem section, when hit by a golf club, the head section is adapted to be detached from the stem section so that the head section follows the swing of the golf club. In this way, this reduces breakage of the golf tee. Further, different lengths (or heights) of the head section may be used and attached to the stem section so that the golf tee can be used to support a golf bail at different heights relative to the ground or grass. Further, with the head section removed, the stem section may be used as a “short tee”.

Preferably, the golf tee comprises a connection member configured to tie the stem section to the head section and which enables the head section to be detached from stem section. In this way, when the head section is struck by a golf club and becomes detached from the stem section, the connection member prevents the head section from being separated from the stem section. Since the stem section is likely to be planted into the ground, this reduces the chance of sending the golf tee flying and thus, there is no need to spend time searching for the golf tee.

Preferably, the connection member is arranged to be connected to external wails of the stem section and the head section. This is advantageous since the entire golf tee may then be produced as an unitary structure and using a single process, such as injection molding.

The head section may comprise a plurality of mutually spaced fingers for supporting a golf ball. Other arrangements of the fingers are envisaged as long as they are suitable for supporting a golf ball and likewise, other support surface may be possible.

Preferably, the golf tee is made of nylon. As explained earlier, the golf tee may be integrally formed from processes such as injection or blow molding extrusion. In fact, this forms a different aspect of the invention which relates to a method of producing a golf tee comprising, after injection or blow molding to produce a molded golf tee, annealing the molded golf tee in an annealing medium at a temperature of at least 60° C. for at least 2 hours. In this way, it enhances the pliability of the golf tee and also, the strength of the golf tee to withstand the blows of a gold club. Of course, this method may be used to produce the golf tee of the first aspect.

Preferably, the annealing medium is water and the temperature is preferably between 60° C. and 80° C. Another suitable annealing medium is oil and other suitable annealing mediums may be used. Preferably, annealing time is from 2 hours up to 10 hours.

### BRIEF DESCRIPTION OF THE DRAWINGS

An embodiment of the invention will now be described, by way of example, with reference to the accompanying drawings in which,

FIG. 1 is a schematic view of a golf tee having a head section, a stem section and a connection member according to a preferred embodiment of the invention;

FIG. 2 is a top view of the golf tee of FIG. 1;

FIG. 3 is another view of the golf tee of FIG. 1 with the head section detached from the stem section;

FIG. 4 illustrates how the golf tee of FIG. 1 is used to support a golf ball;

FIG. 5 illustrates how the head section is detached from the stem section when struck by a golf club; and

FIG. 6 shows the golf tee of FIG. 1 with the head section removed and the stem section being used to support a golf ball directly.

### DETAILED DESCRIPTION OF THE PREFERRED EMBODIMENT

FIG. 1 is a golf tee 100 according to a preferred embodiment of the invention and is made from nylon. The golf tee 100 includes a stem section 102 and a head section 104 releasably attached to the stem section 102. The golf tee 100 also includes a flexible connection member 106 arranged to tie the stem section 102 and the head section 104.

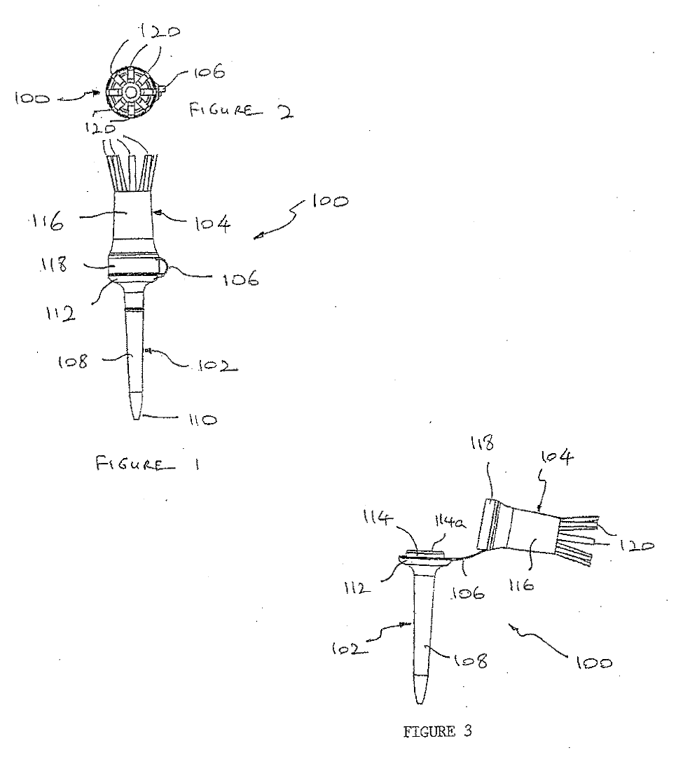

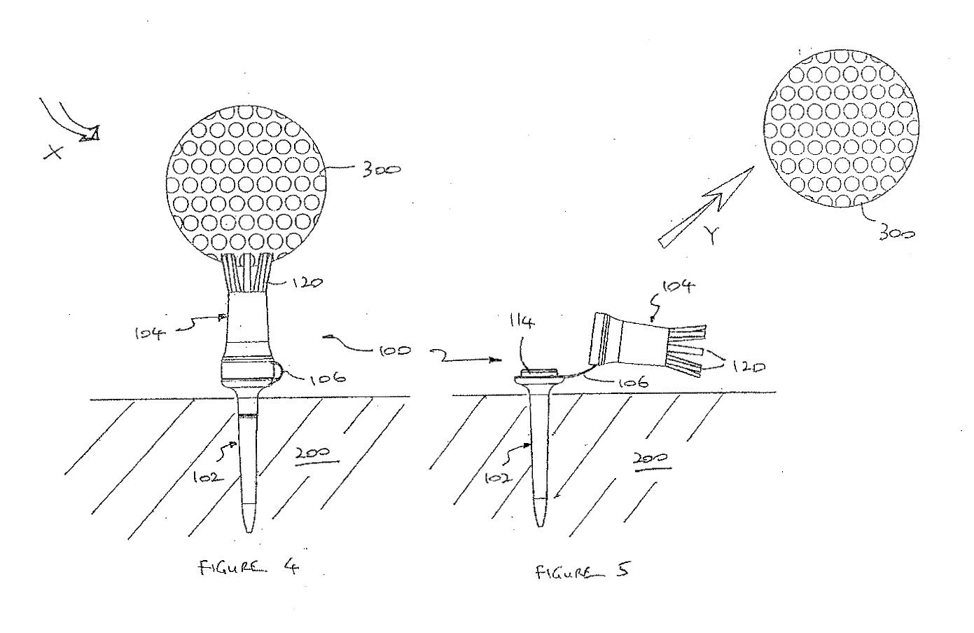

The stem section 102 has a tapered cylindrical body 108 with a pointed end 110 to facilitate insertion of the golf tee 100 into the ground (which may have grass). At the other end of the stem section 102 is a mating portion 112 which is generally circular and a circular engagement portion 114 is provided on the mating portion 112. The circular engagement portion 114 is shown in FIG. 3 which illustrates the head section 104 detached from the stem section 102 and the circular engagement portion 114 has a relatively flat top surface 114a.

The head section 104 has a generally cylindrical body 116 that is hollow so that the head section 104 is lighter. At an end of the head section 104 nearest to the stem section 102 is a hollow mating portion 118 which cooperates with the circular engagement portion 114 to enable the head section 104 to be frictionally attached to the stem section 102. At the other end of the head section 104 is a plurality of mutually spaced and radially projecting fingers 120. FIG. 2 is a top view of the golf tee 100 showing a clearer view of the fingers 120.

The connection member 106 of the golf tee 100 is flexible and its length is configured to allow the head section 104 to be freed or detached from the stem section 102. The flexibility and pliability of the connection member 106 is necessary to withstand the force of a golf club hitting the head section 104, enabling the head section 104 to be detached from the stem section 102 and still maintaining the connection with both the head section 104 and the stem section 102 while being able to allow the head section 104 to be re-attached to the stem section 102.

In this embodiment, the golf tee 100 is integrally formed by convention injection molded process, and then followed by an annealing process. With the connection member 106 attached to the head section 104 and stem section 102 externally, this allows the golf tee 100 to be produced by a single injection molding process. During the annealing process, the molded golf tee 100 is submerged in hot water at a temperature of at least 60° C. for at least two hours. This is to increase the pliability of the structure of the golf tee 100 in particular the connection member 106. It is preferred for the annealing temperature to be between 60° C. and 80° C. and the time from at least two hours up to ten hours.

To use the golf tee 100, the head section 104 is attached to the stem section 102 and the stem section 102 of the golf tee 100 is fully or partially inserted into the ground 200 depending on how high the golf ball is to be raised above the ground 200. This is illustrated in FIG. 4. A golf ball 300 is then placed on the top of the golf tee 100 as supported by the plurality of fingers 120. It should be, noted that if the direction of the swing of the golf club (not shown) to hit the golf ball is in the direction X, the golf tee 100 should be positioned so that the connection member 106 faces away from and along the direction of the swing X, as is shown in FIG. 4. In this way, as the golf club strikes the golf ball 300 and/or the head section 104 (with follow-through swing of the golf club shown as direction Y in FIG. 5), the force detaches the head section 104 from the stem section 102 as shown in FIG. 5 and reduces damage to the connection member 106. The connection member 106 thus helps to reduce the chance of the head section 104 flying off since the stem section 102 being planted into the ground would restrict the movement of the connection member 106. Therefore, it is unlikely that the golf tee 100 would go missing and this reduces the need to search for it and delaying the game. The configuration of the golf tee and also the nylon material reduces the possibility of breaking the golf tee 100 when it is struck by a golf club.

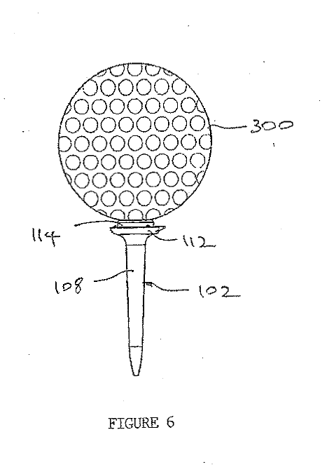

The described embodiment should not be construed as limitative. For example, the plurality of fingers 120 for supporting a golf ball may be replaced by a conventional slightly concave support (i.e. dish-shaped supporting surface) adapted to support a golf ball. Also, the connection member 106 is not absolutely necessary since it is envisaged that a variation is for the head section 104 to be replaceable by another head section, for example which has a longer body in order to raise the golf ball higher above the ground when teeing off. Thus, different lengths/heights of the head section 104 may be manufactured to adapt to different playing requirements and a selected head section 104 is then attached to the stem section 102 when desired. Further, the head section 104 may be removed (for example, when damaged), and the stems section 102 may be used as a “short tee”, as shown in FIG. 6. In this case, it may be preferred to configure the engagement portion 114 to have a slightly concave top surface 114a to facilitate support of a golf ball.

Instead of nylon, other suitable material may be used. Also, other than injection molding, blow molding may be used to make the golf tee 100 of the present invention. Of course, other suitable techniques may be used too. Instead of using water as the annealing medium, other suitable annealing mediums may be used, such as oil and the annealing temperature and time period are adjusted accordingly, if necessary.

Having now fully described the invention, it should be apparent to one of ordinary skill in the art that many modifications can be made hereto without departing from the scope as claimed.

1-10. (canceled)

11. A method of producing a golf tee comprising, after injection or blow molding to produce a molded golf tee, annealing the molded golf tee in an annealing medium at a temperature of at least 60° C. for at least 2 hours and up to 10 hours.

12. A method of producing a golf tee according to claim 11, wherein the molded golf tee is annealed in the annealing medium at a temperature between 60° C. and 80° C.

13. A method of producing a golf tee according to claim 11, wherein the annealing medium comprises water.

14. A golf tee comprising
a stem section insertable to the ground;
a head section for supporting a golf ball and arranged to be releasably attached to the stem section, wherein the stem section includes an engagement portion to which the head section is releasably attachable and which is also for supporting a golf ball when the head section is unattached to the stem section; wherein the golf tee is integrally formed as an unitary item from one material in a single molding step.

15. A golf tee according to claim 14, further comprising a connection member configured to tie the stem section to the head section and which enables the head section to be detached from stem section.

16. A golf tee according to claim 15, wherein the connection member is arranged to be connected to external walls of the stem section and the head section.

17. A golf tee according to claim 14, wherein the head section further comprises a plurality of mutually spaced fingers for supporting a golf ball.

18. A golf tee according to claim 14, wherein the golf tee is made of nylon.
